(19) United States
(12) Patent Application Publication
(10) Pub. No.: US 2010/0009825 A1
(43) Pub. Date: Jan. 14, 2010

(54) Compliant Service Transfer Module for Robotic Tool Changer

(75) Inventors: Daniel Allen Norton, Cary, NC (US); Michael Joseph Gala, Apex, NC (US)

Correspondence Address: COATS & BENNETT, PLLC, 1400 Crescent Green, Suite 300, Cary, NC, 27518, US

(73) Assignee: ATI INDUSTRIAL AUTOMATION, INC., Apex, NC (US)

(21) Appl. No.: 12/171,021

(22) Filed: Jul. 10, 2008

(51) Int. Cl. B23Q 3/155

(52) U.S. Cl. 483/58; 901/41

(57) ABSTRACT

A compliant service transfer module, which transfers services such as electricity, data, pneumatic fluid, etc., between a robotic arm and an attached tool, aligns service transfer points as the two units of the module mate, when the units are misaligned. A floating structure disposed in the first unit is operative to move laterally within a chamber in the housing of the first unit, to align service transfer points with the corresponding service transfer points of a second unit, when the two units are mated together but are not fully aligned. The floating structure protrudes from the first housing, and in the case of misalignment, contacts an angled inner wall of a chamber in the housing of the second unit, which moves the floating structure laterally to align the service transfer points. The floating structure returns to a default, centered position when the two units are not mated together.

### FIELD OF THE INVENTION

The present invention relates generally to robotic tool changers, and in particular to a service transfer module for a robotic tool changer that exhibits mechanical compliance.

### BACKGROUND

Robots are widely utilized in industrial assembly line applications to perform repetitive tasks very precisely without the need for human operation, interaction, or supervision. For example, robots are commonly used in the automotive industry to perform a number of tasks such as material handling, cutting, welding, and the like.

To amortize the considerable cost of an industrial robot over a variety of tasks, the robot arm is typically separate from a diverse array of tools, which are removably attached to the end of the robot arm. To facilitate this plurality of tools, a tool changer—comprising “master” and “tool” devices—may be interposed between a robot arm and each tool that may be attached to it. The robot arm typically terminates in a master device. A corresponding tool device is connected to each tool that may be attached to the robot arm. A mechanical coupling mechanism in the tool changer positively locks the master and tool devices together for the duration of the use of the tool on the robot arm, and releases the tool from the robot arm upon completion of the tool's tasks. The mechanical coupling mechanism can be manually actuated or actuated by a powered means such as pneumatic pressure or electric motor.

The tool changer may additionally provide for the transfer of services from the robot arm to the tool, such as electrical power, pneumatic fluid, or the like. The modules that accomplish this are designed in a modular fashion, and may be added to the master and tool devices of a tool changer as necessary, based on the tool and its task. A service transfer module comprises a master unit, connected to the master device of the tool changer, and a tool unit, connected to the tool device of the tool changer. When the master and tool devices are coupled, the master and tool units of each service transfer module are mated, and complete a path for the passing of services from the robot arm to the tool, or vice versa.

The master and tool devices of a robotic tool changer may include an alignment, or centering, feature, to facilitate coupling when the robotic arm and a desired tool are not perfectly aligned. In some designs, the service transfer modules attached to the master and tool devices may mate before the tool changer fully couples the master and tool devices together. In this case, there may be a slight misalignment between the master and tool units of a service transfer module, prior to the centering feature of the tool changer fully aligning the master and tool devices as they are coupled together. In other cases, the master and tool devices of a tool changer may be aligned, but the master and tool units of a service transfer module are mounted thereon in slightly offset positions, causing a misalignment. This misalignment may cause the service transfer units to not achieve a proper mating, which may result in, e.g., pneumatic fluid leaks, shorted electrical connections, and the like.

In other cases, the master and tool devices of a tool changer may be fully coupled and initially aligned, but the tool side of the robot arm may experience an overloaded condition. The overloaded condition may be the result of the robot picking up a payload that is too heavy, or moving a payload too fast, causing excessive G forces. In this case the master and tool units of a service transfer module are initially aligned, but then experience significant gap separation. This gap separation is the same as misalignment and may cause the service transfer units to not achieve a proper mating, which may result in, e.g., pneumatic fluid leaks, shorted electrical connections, and the like.

### SUMMARY

According to one or more embodiments of the present invention, a floating structure disposed in a first unit of a service transfer module is operative to move laterally within a chamber in the housing of the first unit, to align service transfer points with the corresponding service transfer points of a second unit of the service transfer module, when the two units are mated together but are not fully aligned. The floating structure protrudes from the first housing, and in the case of misalignment, contacts an angled inner wall of a chamber in the housing of the second unit, which moves the floating structure laterally to align the service transfer points. The floating structure returns to a default, centered position when the two units are not mated together.

### BRIEF DESCRIPTION OF THE DRAWINGS

FIG. 1 is a view of a representative industrial robot.

FIG. 2 is a perspective view of a tool changer, with an attached service transfer module, in a decoupled position.

FIG. 3 is a perspective view of the tool changer of FIG. 2 in a coupled position.

FIG. 4 is a perspective view of the service transfer module of FIGS. 2 and 3, in an unmated position.

FIG. 5 is a section view of the service transfer module of FIG. 2.

FIG. 6 is a section view of the service transfer module of FIGS. 2-5, in a misaligned and partially mated position.

FIG. 7 is a section view of the service transfer module of FIG. 3.

### DETAILED DESCRIPTION

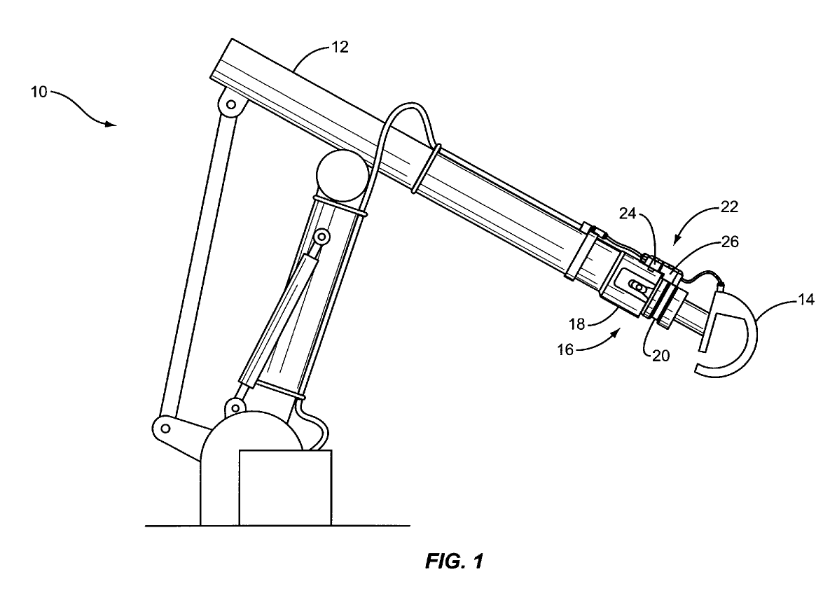

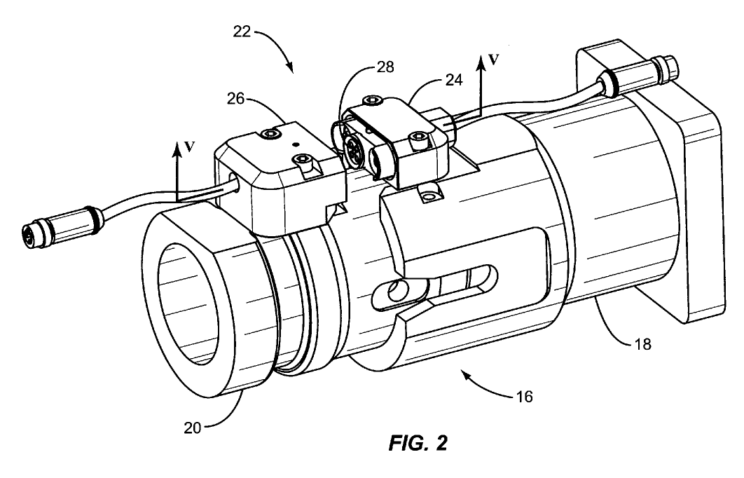

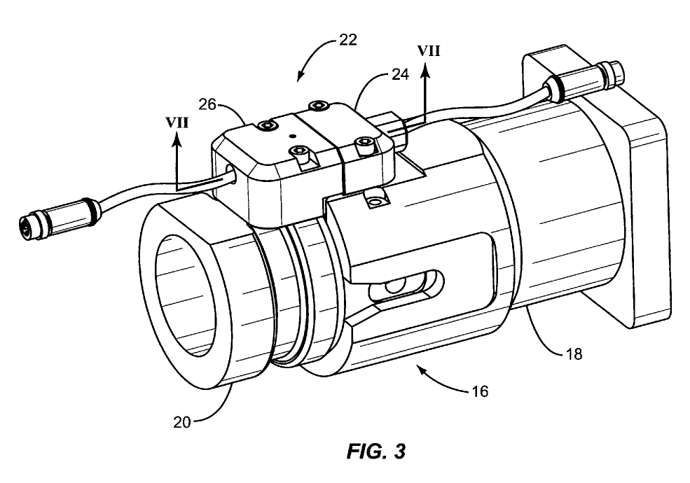

FIG. 1 depicts a representative industrial robot, indicated generally at 10. The robot 10 comprises a robotic arm 12 that moves in a broad number of directions and axes with high precision. A tool 14, in this case a welding tool, is attached to the robotic arm 12. Interfacing the robotic arm 12 to the tool 14 is a robotic tool changer 16, comprising a master device 18 connected to the robotic arm 12 and a tool device 20 connected to the tool 14. The robotic tool changer 16 provides a selectively actuated mechanical coupling between the robotic arm 12 and the attached tool 14. Another tool device 20 may be connected to a different tool (not shown), allowing the robot 10 to perform a broad variety of tasks by swapping tools 14. The tool changer 16 is depicted in greater detail, without the robotic arm 12 or tool 14, in a decoupled state in FIG. 2, and in a coupled state in FIG. 3.

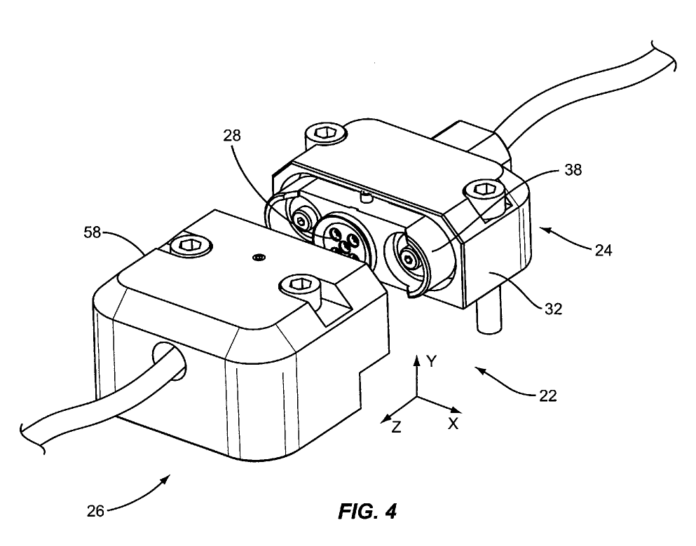

Different tools require different services. For example, the welding tool 14 requires high-current electrical power. A different tool may require pneumatic fluid, hydraulic fluid, data transfer in the form of electrical or optical signals, or the like. To effect the transfer of services from the robotic arm 12 to an attached tool 14 (and, if necessary, vice versa), one or more service transfer modules 22 are connected to the robotic tool changer 16. Each service transfer module 22 comprises a master unit 24 connected to the master device 18 of a tool changer 16, and a tool unit 26 connected to at least one tool device 20 of the robotic tool changer 16. When the master and tool devices 18, 20 of the tool changer 16 couple together—that is, when a tool 14 is attached to the robotic arm 12—the master and tool units 24, 26 of the service transfer module 22 also mate, and one or more services are transferred across the robot/tool interface. The service transfer module 22 is depicted, in an unmated state, in greater detail in FIG. 4.

In operation, the master and tool units 24, 26 of the service transfer module 22 are connected to master and tool devices 18, 20 of the tool changer 16, respectively. As such, the master unit 24 mates to the tool unit 26 when the master device 18 on the robotic arm 12 moves toward, and couples to, the tool device 20 on a tool 14. This linear movement is along the z-axis as depicted in FIG. 4. In particular, the master and tool units 24, 26 mate such that service transfer points 28 on the master and tool units 24, 26 are aligned. A service transfer point 28 is the position or mechanism on a master unit 24 or tool unit 26 that effects transfer of the service across the robot/tool interface. For example, an electrical contact is a service transfer point 28 for transferring electronic signals. Similarly, a valve is a service transfer point 28 for transferring pneumatic fluid. Obviously, the service transfer points 28 of the master and tool units 24, 26 of a service transfer module 22 should be aligned when the master and tool devices 18, 20 of the tool changer 16 are coupled together, to effect proper transfer of the service.

A robotic arm 12 is not always perfectly aligned with a robotic tool 14 when the arm 12 moves to attach the tool 14 (for example, when the robotic arm 12 retrieves the tool 14 from a tool rack). The tool changer 16 may include an alignment mechanism, such one or more conical projections on one of the master or tool devices 18, 20 that mates with a conical receptor on the other device 20, 18, such that the master and tool devices 18, 20 are brought into alignment as the tool changer 16 actuates to mechanically couple the master and tool devices 18, 20 together. If the master and tool units 24, 26 of an attached service transfer module 22 mate prior to the tool changer 16 being fully coupled, the service transfer points 28 may be misaligned. Alternatively, even if the master and tool devices 18, 20 are properly aligned, the master and tool units 24, 26 may be mounted to the tool changer 16 with slight offsets, resulting in a misalignment of the service transfer points 28. Still further, the robotic tool 14 may experience an overload condition whereby excessive force or torque is applied to the tool 14, causing a misalignment between the master and tool devices 18, 20.

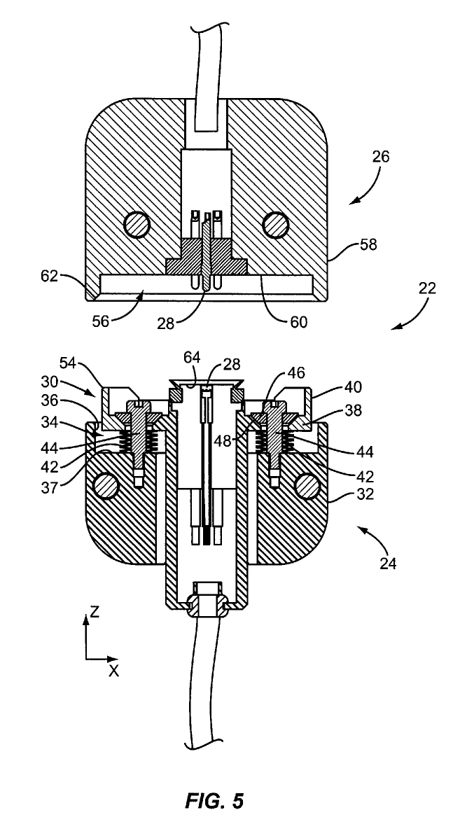

According to the present invention, as best depicted in FIGS. 5-7, one of the master unit 24 or tool unit 26 of a service transfer module 22 includes a compliance mechanism 30 operative to align the service transfer points 28 when the master and tool units 24, 26 mate and are misaligned for any reason. The compliance mechanism 30 is discussed herein, and depicted in FIGS. 3-7, as being disposed within the master unit 24. For a given robotic arm 12, an organization would typically maintain one operative master device 18 (attached to the arm 12), and as many tool devices 20 as there are tools 14 that may be connected to the robotic arm 12. Accordingly, overall costs for the tool changer 16 are minimized by disposing the compliance mechanism 30 in a single master unit 24, rather than replicating the compliance mechanism 30 in every tool unit 26. However, the present invention is not limited to this configuration, and embodiments in which a compliance mechanism 30 is disposed in the tool unit 26 of a service transfer module 22 are within the scope of the present invention.

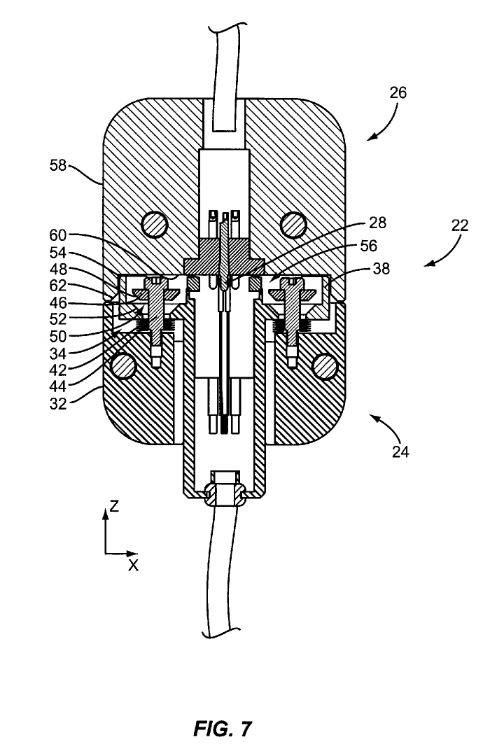

With reference to FIGS. 5 and 7, the master unit 24 includes a housing 32. A chamber 34 is formed in the housing 32, defining an inner wall 36 and a floor 37. A floating structure 38 is disposed partially within the chamber 34 (and extending partially from the chamber 34). The outer wall 40 of the floating structure 38 is spaced apart from the inner wall 36 of the chamber 34, at least in every direction for which compliant motion is desired—i.e., around its entire periphery of the floating structure 38 in the embodiment depicted in FIGS. 4-7. The floating structure 38 does not contact the floor 37 of the chamber 34, but rather is biased away from the floor 37, in a direction towards the tool unit 26 (the z-axis direction as depicted in FIG. 4-7), such as by springs 42.

The floating structure 38 is retained partially within the chamber 34, against the spring 42 bias, by bolts 44 secured to the housing 32. Affixed to each bolt 44 is a shoulder washer 46 having a generally conical surface 48 in the direction of the housing 32. In a default position, assumed when the master unit 24 is decoupled from the tool unit 26, as depicted in FIG. 5, the floating structure 38 is generally centered within the chamber 34 by the conical surfaces 48 of the shoulder washers 46 nestling within corresponding countersink voids 50 formed in the floating structure 38, each void 50 having a conical surface 52 (as best seen in FIG. 7). While the depicted embodiment includes two each of springs 42, bolts 44, and shoulder washers 46 nestled in corresponding countersink voids 50, those of skill in the art will readily realize that other embodiments may include more or fewer such assemblies within the broad scope of the present invention.

In operation, the shoulder washers 46 and conical surfaces 52, under the bias of springs 42, operate to center the floating structure 38 within chamber 34, as depicted in FIG. 5. Those of skill in the art will readily appreciate that if the floating structure 38 is displaced from that position—either laterally in the x-y plane, or if it is “canted” or rotated such that the plane of the floating structure 38 is not parallel to the plane of the floor 39 of the chamber 34, or both—the spring 42 force and the conical surfaces 52, 62 will act to return the floating structure 38 to its default, centered position, as depicted in FIG. 5 when the force displacing the floating structure 38 is removed.

In the default position depicted in FIG. 5, the floating structure 38 extends at least partially outward of the chamber 34, past the housing 32 of the master unit 24, in the direction of the tool unit 26. A chamfer 54 is formed on the outer edge, or corner, of the floating structure 38. A chamber 56 is formed in the housing 58 of the tool unit 26, defining a floor 60 and an inner wall 62. The inner wall 62 is angled in a concave direction.

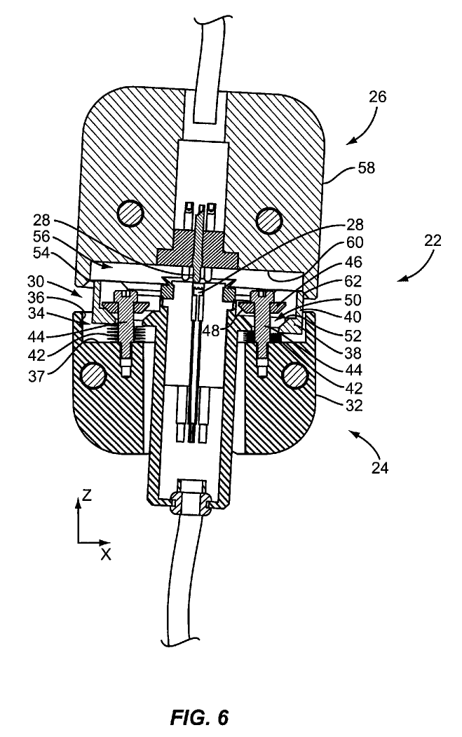

FIG. 6 depicts a case where the master and tool units 24, 26 are not properly aligned as the master unit 24 approaches and contacts the tool unit 26, i.e., as the master unit 24 moves in the z-axis direction. In particular, the tool unit 26 is not aligned vertically with the master unit 24. Due to the misalignment, the initial contact between the master and tool units 24, 26 is between the (right-most, as depicted in FIG. 6) chamfered corner 54 of the floating structure 38 and the corresponding angled inner wall 62 of the chamber 56 in the tool unit 26. As the master unit 24 further advances toward the tool unit 26, the left-most chamfered corner 54 of the floating structure 38 contacts the corresponding angled inner wall 62. The interaction of these angled surfaces 54, 62 may alter the plane of the floating structure 38, as shown, and/or laterally translate the floating structure 38, to align the service transfer points 28 on the floating structure 38 with the corresponding service transfer points 28 on the tool unit 26.

FIG. 7 depicts the master unit 24 and tool unit 26 of the service transfer module 22 in a fully mated position (i.e., when the master device 18 and the tool device 20 of the tool changer 16 are fully coupled, locking a tool 14 to the robot arm 12). The service transfer points 28, in this case electrical contacts, are aligned and engaged. A forward surface 64, on which the service transfer points 28 are disposed, abuts the floor 60 of the chamber 56 in the housing 58 of the tool unit 26. This displaces the floating structure 38 more fully into the chamber 34 in the housing 32 of the master unit 24, as the master unit 26 housing 32 and tool unit 28 housing 58 come into contact. In this mated position, the springs 42 press the floating structure 38 against the tool unit 26, pressing the service transfer points 28 of the master and tool units 24, 26 together.

According to the present invention, proper alignment of the service transfer points 28 is achieved as the master and tool units 24, 26 of a service transfer module 22 mate but are not aligned. This prevents leakage of services and/or damage caused by unaligned service transfer points 28, improving the safety and reliability of industrial robotic operations.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A first service transfer unit for a robotic tool changer, comprising:
a housing adapted to be attached to a first device of a robotic tool changer;
one or more service transfer points operative to transfer a service across a robot/tool interface when the first service transfer unit is mated to a second service transfer unit attached to a second device of the robotic tool changer; and
a compliance mechanism operative to align the service transfer points to corresponding service transfer points of second service transfer unit when the first and second service transfer unit are mated but are not aligned.

2. The unit of claim 1 wherein the compliance mechanism comprises a floating structure disposed partially within the housing, the floating structure not rigidly connected to the housing, and operative to move within the housing to a position where the service transfer points are aligned with those of the second service transfer module.

3. The unit of claim 2 wherein the floating structure is biased away from the housing.

4. The unit of claim 3 wherein the floating structure is retained partially within the housing, against the bias, by one or more fasteners connected to the housing and operative to arrest movement of the floating structure in a direction away from the housing.

5. The unit of claim 4 wherein centering elements on the fasteners are operative to align the floating structure to a default position within the housing.

6. The unit of claim 2 wherein the floating structure extends partially from the housing and first contacts the second service transfer unit as the first and second units are coupled, and wherein angled surfaces on at least one of the first and second units are operative to move the floating structure into a position where the service transfer points on the first and second unit are aligned.

7. The module of claim 1 wherein the first service transfer unit is attached to the master device of the robotic tool changer.

8. A service transfer module for a robotic tool coupler, comprising:
first and second housings, each adapted to be attached to a different device of the tool coupler and to mate together as one housing is moved toward the other housing in a first direction, each housing having a chamber formed therein in a direction facing the other housing;
a floating structure, having at least one service transfer point, disposed partially within the chamber of the first housing, the structure extending outwardly of the housing and operative to move laterally within the chamber in a plane normal to the first direction so as to align the service transfer points with corresponding service transfer points disposed in the second housing.

9. The module of claim 8 wherein the floating structure is moved laterally within the chamber of the first housing as it enters the chamber of the second housing as the housings are moved together.

10. The module of claim 9 wherein an inner wall of the chamber of the second housing is angled in a concave direction, and wherein the floating structure is moved laterally within the chamber of the first housing by contacting the angled inner wall of the chamber of the second housing.

11. The module of claim 10 wherein the outer edge of the floating structure, in the direction of the second housing, is chamfered.

12. The module of claim 8 wherein the floating structure is biased away from the first housing, and retained partially within the chamber of the first housing in a default, generally centered position when the first housing is not mated with the second housing.

13. The module of claim 12 wherein the floating structure is retained by a plurality of fasteners secured to the housing and extending through the floating structure, a conical shoulder washer on each fastener operative to urge the floating structure to the default position by nestling into a corresponding conical countersink void in the floating structure.

14. A service transfer unit for a robotic tool changer comprising a master device and a tool device operative to be selectively coupled together, comprising:
a master unit comprising a housing attached to the tool changer master device, the master unit operative to supply or receive a service via one or more service transfer points; and
a tool unit comprising a housing attached to the tool changer tool device, the tool unit operative to receive or supply the service via one or more corresponding service transfer points;
wherein the master and tool units are operative to transfer the service when the master and tool devices of the tool changer are coupled together; and
wherein one of the master and tool units features a compliance mechanism operative to align the service transfer points when the master and tool units mate but are not aligned.

15. The unit of claim 14 wherein the compliance mechanism comprises a floating structure disposed partially within the housing, the floating structure not rigidly connected to the housing, and operative to move within the housing to a position where the service transfer points are aligned with those of the other service transfer unit.

16. The unit of claim 15 wherein the floating structure is biased away from the housing.

17. The unit of claim 16 wherein the floating structure is retained partially within the housing, against the bias, by one or more fasteners connected to the housing and operative to arrest movement of the floating structure in a direction away from the housing.

18. The unit of claim 17 wherein centering elements on the fasteners are operative to align the floating structure to a default position within the housing.

19. The unit of claim 15 wherein the floating structure extends partially from the housing and first contacts the other service transfer module when the two units are coupled, and wherein angled surfaces on at least one of the units are operative to move the floating structure into a position where the service transfer points on the two units are aligned.

20. The module of claim 14 wherein the compliance mechanism is disposed in the master service transfer unit.
